(19) United States
(12) Patent Application Publication
(10) Pub. No.: US 2017/0163816 A1
(43) Pub. Date: Jun. 8, 2017

(54) MOBILE TERMINAL AND CONTROLLING METHOD THEREOF

(71) Applicants: LE HOLDINGS (BEIJING) CO., LTD., Beijing (CN); LEMOBILE INFORMATION TECHNOLOGY (BEIJING) CO., LTD, Beijing (CN)

(72) Inventor: Huan ZHAO, Beijing (CN)

(21) Appl. No.: 15/244,761

(22) Filed: Aug. 23, 2016

Related U.S. Application Data
(63) Continuation of application No. PCT/CN2016/088727, filed on Jul. 5, 2016.

(30) Foreign Application Priority Data
Dec. 8, 2015 (CN) 201510898404.1

(51) Int. Cl. H04M 11/00; H04W 4/14

(52) U.S. Cl. CPC H04M 11/007; H04W 4/14

(57) ABSTRACT

Disclosed are a mobile terminal and controlling method thereof, the method comprises: receiving short message information sent by a first mobile terminal, and judging whether the short message information contains instruction information; and initiating, according to the instruction information, a service program to execute a corresponding operation if it judges that the short message information contains instruction information. In the invention, a mobile terminal is made to execute a corresponding operation according to a received short message, and hence the mobile terminal can be controlled more conveniently.

### CROSS-REFERENCES TO RELATED APPLICATION

The present application is continuation of International application No. PCT/CN2016/088727, filed on Jul. 5, 2016, which is based upon and claims priority to Chinese Patent Application No. 2015108984041, filed on Dec. 8, 2015, the disclosure of which is incorporated herein by reference in its entirety.

### TECHNICAL FIELD

This disclosure relates to the technical field of mobile terminals, and in particular, to a mobile terminal and controlling method thereof.

### BACKGROUND

With the development of communication technologies, a mobile terminal has more and more functions. A payment function is one of the functions of a mobile terminal. Accordingly, software with a corresponding payment function, for example, personal finance-related software such as Alipay and Bank Terminal Application, etc., will be installed on a mobile terminal,

In many cases, the software with a payment function on a mobile terminal may record the logon information of a user. If a user loses his/her mobile terminal carelessly, an illegal user may logs on the application software, such as Alipay, etc., via the lost mobile terminal for business transaction; as a result, loss of user assets may occur. Additionally, if booking software is installed on the mobile terminal, the personal information of the user will generally be recorded; moreover, information related to the user will be stored inside the mobile terminal. If such information is stolen and used by an illegal user, a serious consequence may occur.

### SUMMARY

In view of this, the disclosure provides a mobile terminal and controlling method thereof.

In a first aspect, one embodiment of this disclosure provides a method for controlling a mobile terminal, which includes: at a second mobile terminal; receiving short message information sent by a first mobile terminal, and judging whether the short message information contains instruction information; and initiating, according to the instruction information, a service program to execute a corresponding operation if the second mobile terminal judges that the short message information contains instruction information.

In a second aspect, one embodiment of this disclosure further provides a non-volatile computer storage medium, which stores computer executable instructions, wherein the computer executable instructions are used to perform the method according to any one of embodiments of the present application.

In a third aspect, one embodiment of this disclosure further provides a mobile terminal, which comprises: at least one processor, and a memory communicably connected with the at least one processor for storing instructions executable by the at least one processor, wherein execution of the instructions by the at least one processor causes the at least one processor to perform the method according to any one of embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart showing a method for controlling a mobile terminal according to Embodiment 1 of this disclosure;

FIG. 2 is a flow chart showing a method for controlling a mobile terminal according to Embodiment 2 of this disclosure;

FIG. 3 is a flow chart showing a method for controlling a mobile terminal according to Embodiment 3 of this disclosure;

FIG. 4 is a flow chart showing a method for controlling a mobile terminal according to Embodiment 4 of this disclosure;

FIG. 5 is a block diagram showing the structure of a device for controlling a mobile terminal according to Embodiment 5 of this disclosure; and

FIG. 6 is a schematic diagram showing the hardware structure of a mobile terminal according to Embodiment 7 of this disclosure.

### DETAILED DESCRIPTION

This disclosure will be illustrated in detail in conjunction with the drawings and embodiments. It may be understood that, the embodiments described here are only used for explaining this disclosure, rather than limiting the scope of this disclosure. Additionally, it should be noted that, for easy description, the drawings only show the parts related to this disclosure, rather than the whole structure.

### Embodiment 1

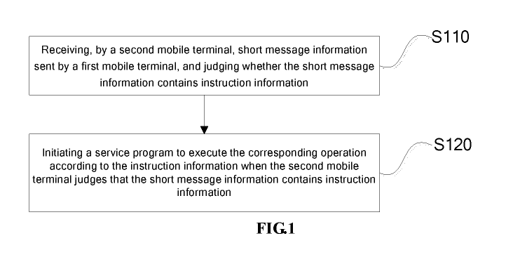

FIG. 1 is a flow chart showing a method for controlling a mobile terminal according to Embodiment 1 of this disclosure. The solution of this embodiment may be executed by a device for controlling a mobile terminal, and the device may be implemented in a hardware and/or software mode. As shown in FIG. 1, the method includes:

In S110, a second mobile terminal receives short message information sent by a first mobile terminal, and judges whether the short message information contains instruction information.

In the present embodiment, the instruction information may include a target application uninstallation instruction, a target communication record deletion instruction and a target picture file deletion instruction.

Exemplarily, the judging, by the second mobile terminal, whether the short message information contains instruction information includes: monitoring, by the second mobile terminal via a short message application, the received short message information, and resolving the content of the short message information; and judging, by the second mobile terminal, whether the content of the short message information contains instruction information.

If the content of the short message information contains a first symbol and a name of an application, it judges that the instruction information is a target application uninstallation instruction;

If the content of the short message information contains a second symbol and a contact name or contains a second symbol and a contact telephone number, it judges that the instruction information is a target communication record deletion instruction;

If the content of the short message information contains a third symbol and a picture folder name, it judges that the instruction information is a target picture file deletion instruction.

The first symbol, the second symbol and the third symbol may be a combination of digits and/or alphabets and may be set flexibly according to user demand. Exemplarily, when the short message is set to contain a first symbol “uninstall”, a second symbol “*” and a third symbol “&”, it will be respectively an application uninstallation instruction, a communication record deletion instruction and a picture file deletion instruction. For example, if the content of the short message is “uninstall Alipay”, the instruction information in the content of the short message will be an instruction for deleting Alipay; if the content of the short message is “*Zhangsan”, the instruction information in the content of the short message will be an instruction for deleting the communication record information of Zhangsan; if the content of the short message is “& tour”, the instruction information in the content of the short message will be an instruction for deleting the picture information with a folder name of “tour”.

In S120, a service program is initiated to execute the corresponding operation according to the instruction information when the second mobile terminal judges that the short message information contains instruction information.

In the present embodiment, when the second mobile terminal judges that the short message information contains instruction information, it initiates a service program to execute the corresponding operation according to the instruction information; when the second mobile terminal judges that the short message information does not contain instruction information, it will not initiates the service program. Optionally, when the second mobile terminal judges that the short message information contains a target application uninstallation instruction, it initiates a service program according to the instruction to uninstall the target application. When the second mobile terminal judges that the short message information contains a target communication record deletion instruction, it initiates a service program according to the instruction to delete the target communication record. When the second mobile terminal judges that the short message information contains a target picture file deletion instruction, it initiates a service program according to the instruction to delete the target picture file.

It should be noted that, in the present embodiment, the instruction information is not limited to the target application uninstallation instruction, the target communication record deletion instruction and the target picture file deletion instruction, and the instruction information may also be other instructions, for example, a target short message deletion instruction and a browser record deletion instruction, etc.

In order to avoid a vicious operation on the second mobile terminal by other users, it may set a setting password in the short message information, or the corresponding instruction is allowed to be executed only when the short message information comes from the first mobile terminal with a set number.

In the method for controlling a mobile terminal according to the embodiment of this disclosure, the second mobile terminal executes a corresponding operation according to the instruction information in a short message received that is sent by a first mobile terminal, so that the first mobile terminal may control the second mobile terminal via a short message, and when the second mobile terminal is lost, it may be convenient for the user to control the second mobile terminal, thereby ensuring the security of user assets and personal information.

### Embodiment 2

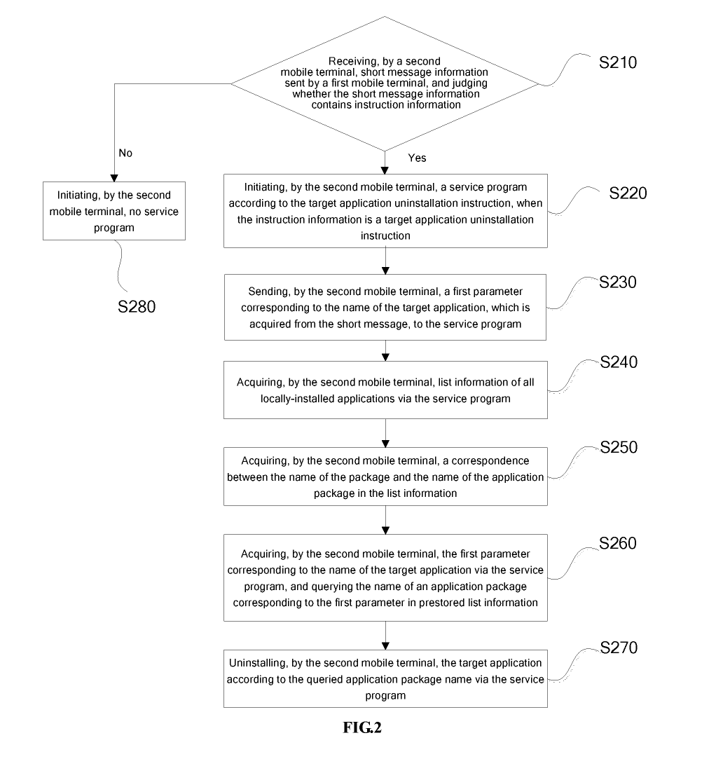

FIG. 2 is a flow chart showing a method for controlling a mobile terminal according to Embodiment 2 of this disclosure. On the basis of the above embodiment, when the instruction information is a target application uninstallation instruction, the initiating, according to the instruction information, a service program to execute a corresponding operation optionally includes: initiating, by the second mobile terminal, a service program according to the target application uninstallation instruction, and sending a first parameter corresponding to a name of the target application, which is acquired from the short message, to the service program; acquiring, by the second mobile terminal, the first parameter corresponding to the name of the target application via the service program, and querying a name of an application package corresponding to the first parameter in prestored list information; and querying, by the second mobile terminal, the name of the application package via the service program, and uninstalling the target application.

Therefore, by initiating via the second mobile terminal a service program to query the name of the application package corresponding to the target application and uninstalling the target application according to the name of the application package, it may be realized that the first mobile terminal controls the second mobile terminal to uninstall the target application.

Optionally, before acquiring, by the second mobile terminal, the first parameter corresponding to a name of the target application, the method further includes: acquiring, by the second mobile terminal, list information of all locally-installed applications via the service program; and acquiring, by the second mobile terminal, a correspondence between the name of the application and the name of the application package in the list information; wherein, the list information at least includes the names of all the installed applications and the names of the application packages.

Therefore, by acquiring list information of the locally-installed applications via the second mobile terminal, it may be favorable for querying the name of the application package corresponding to the name of the target application in the short message information.

Based on the above solution, as shown in FIG. 2, this embodiment provides a technical solution as follows.

In S210, a second mobile terminal receives short message information sent by a first mobile terminal, and judges whether the short message information contains instruction information;

When it judges that the short message information contains instruction information, it turns to S220; when it judges that the information does not contain instruction information, it turns to S280.

In S220, the second mobile terminal initiates a service program according to the target application uninstallation instruction, when the instruction information is a target application uninstallation instruction.

In S230, the second mobile terminal sends a first parameter corresponding to the name of the target application, which is acquired from the short message, to the service program.

In the present embodiment, the service program is a function program in the short message application of the second mobile terminal. Wherein, the name of the service program is “service”. The first parameter may be set autonomously as required, for example, the first parameter corresponding to Alipay is set as 1, the first parameter corresponding to QQ is set as 2, the first parameter corresponding to 12306 Booking Application is set as 3, and the like.

The second mobile terminal initiates a service program according to the target application uninstallation instruction, and sends the first parameter corresponding to the name of the target application, which is acquired from the short message, to the service program. For example, when the target application uninstallation instruction in the short message is an Alipay uninstallation instruction, the second mobile terminal initiates the service program and sends the first parameter “1” corresponding to Alipay to the service program “service”.

In S240, the second mobile terminal acquires list information of all locally-installed applications via the service program.

In the present embodiment, the second mobile terminal acquires the list information of all the locally-installed applications via the service program, and saves the list information. The list information may be saved in a folder “MAP”.

Wherein, the codes for acquiring a list of the installed applications (non-system application) are as follows:

public Map<String, String> getInstalledAppMap( ){
Map<String, String> appMap = new HashMap<String, String>( );
List<PackageInfo>packages=getPackageManager( ).getInstalledPackages(0);
for(int i=0;i<packages.size( );i++) {
PackageInfo packageInfo = packages.get(i);
String appName =
packageInfo.applicationInfo.loadLabel(getPackageManager( )).toString( );
String packageName = packageInfo.packageName;
If(packageInfo.applicationInfo.flags&ApplicationInfo.FLAG_SYSTEM)==0) {
appMap.put(appName, packageName);
}
}
return appMap;
}

In S250, the second mobile terminal acquires a correspondence between the name of the application and the name of the application package in the list information.

In the present embodiment, the list information of all locally-installed applications at least contains a name of an application and a name of an application package, and the name of the application and the name of the application package have a one-to-one correspondence. The name of the application is saved in a Key file under MAP, and the name of the application package is saved in a value file under MAP. In order to guarantee a better storage of the name of the application and the name of the application package, the name of the package and the name of the application package are both stored in the form of a parameter. For example, Table 1 is a part of a list showing the correspondence between the name of the application and the name of the application package. Wherein, the corresponding application name of the application Alipay in the list is “1”, and the name of the application package corresponding to the name Alipay is “a”, then the name of the application package corresponding to the application Alipay will be “a”.

In S260, the second mobile terminal acquires the first parameter corresponding to the name of the target application via the service program, and querying the name of an application package corresponding to the first parameter in prestored list information.

TABLE 1

| name of | Name of Application | Name of Application |
|---|---|---|
| Application | In List | Package In List |
| Alipay | 1 | a |
| QQ | 2 | b |
| Booking Software | 3 | c |

In the present embodiment, for example, the second mobile terminal acquires the first parameter corresponding to Alipay via the service program; for example, in the present embodiment, the first parameter corresponding to Alipay is set as 1, the name of the package corresponding to the first parameter 1 of Alipay queried in a prestored information list is 1, then the name of the application package corresponding to 1 is queried according to the correspondence between the name of the package and the name of the application package in a list stored in MAP, and as queried in Table 1, the name of the application package corresponding to the name of the package 1 in the list is a.

In S270, the second mobile terminal uninstalls the target application according to the queried application package name via the service program.

In the present embodiment, the second mobile terminal uninstalls the target application according to the queried application package name via the service program. For example, the second mobile terminal queries the application package with a name of “a” in the installation path according to the queried application package name “a” via the service program, and deletes the application package “a”. Wherein, the application package “a” is the installation file of Alipay. After the application package “a” of Alipay is deleted from the installation path, the uninstallation of Alipay may be realized.

In the present embodiment, the execution codes for uninstalling the application are as follows:

Uri uri=Uri.parse(“package:”+appMap(“Alipay”));//Acquiring the URI of the name of the application package to be delete

i.setAction(Intent.ACTION_DELETE);//Setting an uninstallation action to be executed

i.setData(uri);//Setting the URI acquired

startActivity(i);

In S280, the second mobile terminal initiates no service program.

If the short message received by the second mobile terminal contains no instruction information, no service program will be initiated.

On the basis of the above embodiment, when a plurality of applications exist in the second mobile terminal, the short message information may contain an instruction for deleting one target applications, thereby deleting the target applications one by one. The short message information may also contain an instruction for deleting a plurality of target applications, thereby realizing batch deletion of the target applications.

The embodiment of this disclosure provides a method for controlling a mobile terminal, wherein, when the instruction information is a target application uninstallation instruction, by initiating via the second mobile terminal a service program to query the name of the application package corresponding to the target application and uninstalling the target application according to the name of the application package, it may be realized that the first mobile terminal controls the second mobile terminal via a short message to uninstall the target application; when the second mobile terminal of the user is lost, it may guarantee the security of user assets and personal information.

### Embodiment 3

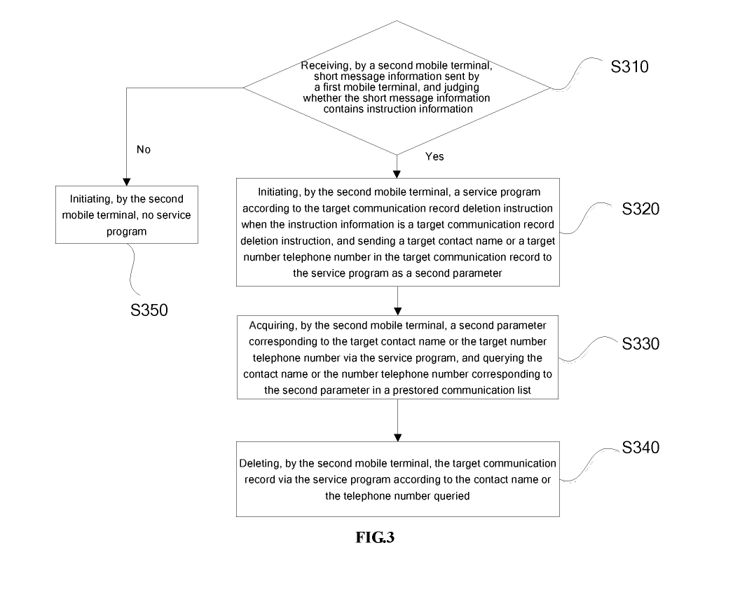

FIG. 3 is a flow chart showing a method for controlling a mobile terminal according to Embodiment 3 of this disclosure; on the basis of the above embodiment, when the instruction information is a target communication record deletion instruction, the initiating according to the instruction information a service program to execute a corresponding operation optionally includes: initiating, by the second mobile terminal, a service program according to the target communication record deletion instruction, and sending a target contact name or a target number telephone number in the target communication record as a second parameter to the service program; acquiring, by the second mobile terminal, the second parameter corresponding to the target contact name or the target number telephone number via the service program, and querying the contact name or the number telephone number corresponding to the second parameter in a prestored communication list; and deleting, by the second mobile terminal, the target communication record via the service program according to the contact name or the number telephone number queried.

Therefore, the second mobile terminal can initiate the service program via the short message information received to delete the target communication record, thereby guaranteeing the security of the personal information of the user.

Based on the above solution, as shown in FIG. 3, the technical solution according to the embodiment of this disclosure is as follows.

In S310, a second mobile terminal receives short message information sent by a first mobile terminal, and judging whether the short message information contains instruction information.

When it judges that the short message information contains instruction information, it turns to S320; when it judges that the short message information does not contain instruction information, it turns to S350.

In S320, the second mobile terminal initiates a service program according to the target communication record deletion instruction when the instruction information is a target communication record deletion instruction, and sends a target contact name or a target number telephone number in the target communication record as a second parameter to the service program.

In the present embodiment, for example, when the target communication record deletion instruction is an instruction for deleting the communication record of Zhangsan, the second mobile terminal initiates the service program according to the instruction and sends the name of Zhangsan as the second parameter to a server, wherein the second parameter may be a combination of digits and/or characters, and the second parameter corresponding to the name of Zhangsan is set as 111.

In S330, the second mobile terminal acquires a second parameter corresponding to the target contact name or the target number telephone number via the service program, and querying the contact name or the number telephone number corresponding to the second parameter in a prestored communication list;

In the present embodiment, the second mobile terminal can acquire a communication list from a database in advance via the service program and stores the communication list. Wherein, the communication list at least contains a name of a contact and a telephone number corresponding to the contact.

In S340, the second mobile terminal deletes the target communication record via the service program according to the queried contact name or the telephone number.

In the present embodiment, for example, when the target communication record deletion instruction is an instruction for deleting the communication record of Zhangsan, the second mobile terminal acquires the second parameter 111 corresponding to Zhangsan and queries the contact name corresponding to 111 in the prestored communication list.

The second mobile terminal deletes the information of Zhangsan in the communication record via the service program according to the contact name (Zhangsan) queried. Wherein, the information of Zhangsan includes the name and the telephone number of Zhangsan.

In S350, the second mobile terminal initiates no service program.

When the short message received by the second mobile terminal contains no instruction information, no service program is initiated.

On the basis of the above embodiment, the target communication record deletion instruction may contain a second symbol and a contact name, or it may contain a second symbol and a telephone number. When the target communication record deletion instruction contains a second symbol and a telephone number, the method by which the second mobile terminal deletes the communication record is the same as the method employed when the target communication record deletion instruction contains a second symbol and a contact name.

On the basis of the above embodiment, the short message information received by the second mobile terminal may contain an instruction for deleting one target contact or telephone number, thereby deleting the target contact or the telephone number one by one. The short message information may also contain an instruction for deleting a plurality of target contacts or telephone numbers, thereby realizing batch deletion of the target contacts or the telephone numbers.

The embodiment of this disclosure provides a method for controlling a mobile terminal, wherein, the second mobile terminal initiates the service program to delete the target communication record by receiving a short message information sent by the first mobile terminal, thereby realizing the control of the second mobile terminal by the first mobile terminal; and when the second mobile terminal is lost, it may guarantee the security of the personal information of the user.

### Embodiment 4

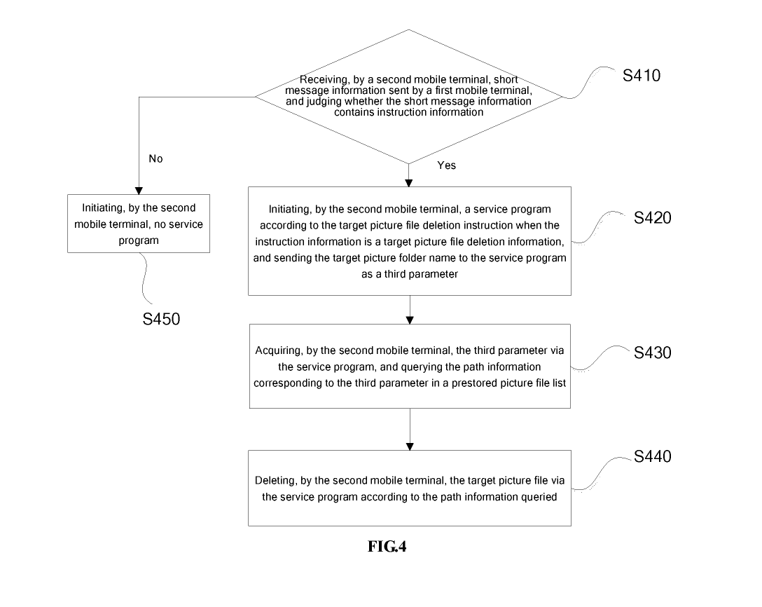

FIG. 4 is a flow chart showing a method for controlling a mobile terminal according to Embodiment 4 of this disclosure. On the basis of the above embodiment, when the instruction information is a target picture file deletion instruction, the initiating according to the instruction information a service program to execute a corresponding operation optionally includes: initiating, by the second mobile terminal, a service program according to the target picture file deletion instruction, and sending the target folder name of the target picture file as a third parameter to the service program; acquiring, by the second mobile terminal, the third parameter via the service program, and querying the path information corresponding to the third parameter in a prestored picture file list; and deleting, by the second mobile terminal, the target picture file via the service program according to the queried path information; wherein, the picture file list at least contains the folder names of all picture files and the path information corresponding to the folder name.

Therefore, the second mobile terminal can initiate the service program via the received short message information to delete the target picture folder, thereby guaranteeing the security of the personal information of the user.

Based on the above solution, as shown in FIG. 4, the technical solution according to the embodiment of this disclosure is as follows:

In S410, a second mobile terminal receives short message information sent by a first mobile terminal, and judging whether the short message information contains instruction information;

When it judges that the short message information contains instruction information, it turns to S420; when it judges that the short message information does not contain instruction information, it turns to S450.

In S420, the second mobile terminal initiates a service program according to the target picture file deletion instruction when the instruction information is a target picture file deletion information, and sends the target picture folder name as a third parameter to the service program;

In the present embodiment, the target picture file deletion instruction contains a third symbol and a target picture folder name. For example, a target picture folder with a name of “tour” exists in the second mobile terminal. The first mobile terminal compiles a short message “third symbol and tour” and sends it to the second mobile terminal, the second mobile terminal judges that the instruction information in the short message is an instruction for deleting a picture file with a name of “tour”, and it sends “tour” to the service program in the form of a third parameter. Wherein, the third parameter is a combination of digits and/or alphabets, for example, the third parameter corresponding to tour is set as al.

In S430, the second mobile terminal acquires the third parameter via the service program, and queries the path information corresponding to the third parameter in a prestored picture file list;

In the present embodiment, the second mobile terminal acquires a picture file list in advance via the service program, wherein the picture file list at least contains the folder names of all picture files and the path information corresponding to the folder name. Wherein, the folder names of all picture files and the path information in the prestored picture file list are stored in the form of parameters.

The second mobile terminal acquires the third parameter via the service program, queries the folder name the same as the third parameter in the prestored picture file list, and queries the corresponding path information according to the folder name. For example, the second mobile terminal acquires “al” via the service program, and it queries the picture folder name, which is the same as “al”, in the prestored picture file list, and then it queries the path information corresponding to “al” according to the queried picture folder name “al”.

In S440, the second mobile terminal deletes the target picture file via the service program according to the queried path information;

In the present embodiment, for example, the second mobile terminal deletes the picture folder with a name of “tour” under the path according to the path information queried.

In S450, the second mobile terminal initiates no service program.

On the basis of the above embodiment, when a plurality of target picture files exist in the second mobile terminal, the short message information may contain an instruction for deleting a target picture file, thereby deleting the picture folders one by one. The short message information may also contain an instruction for deleting a plurality of target picture files, thereby realizing batch deletion of picture folders.

The embodiment of this disclosure provides a method for controlling a mobile terminal, wherein, the second mobile terminal initiates the service program to delete the target picture file by receiving a short message information sent by the first mobile terminal, thereby realizing the control on the second mobile terminal by the first mobile terminal; when the second mobile terminal is lost, it may guarantee the security of the personal information of the user.

### Embodiment 5

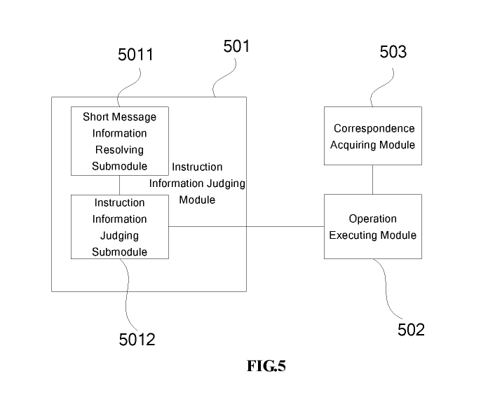

FIG. 5 is a block diagram showing the structure of a device for controlling a mobile terminal according to Embodiment 5 of this disclosure, by which a mobile terminal may be controlled. As shown in FIG. 5, the device includes: an instruction information judging module 501, configured to receive, by a second mobile terminal, short message information sent by a first mobile terminal, and judging whether the short message information contains instruction information; and an operation executing module 502, configured to initiate a service program to execute the corresponding operation according to the instruction information when the second mobile terminal judges that the short message information contains instruction information.

Optionally, the instruction information judging module 501 includes: a short message information resolving submodule 5011 and an instruction information judging submodule 5012.

The short message information resolving submodule 5011 is configured to monitor, by the second mobile terminal via a short message application, the short message information received, and resolving the content of the short message information; and

The instruction information judging submodule 5012 is configured to judge, by the second mobile terminal, whether the instruction information is contained according to the content of the short message information.

Optionally, the instruction information includes: a target application uninstallation instruction, a target communication record deletion instruction and a target picture file deletion instruction.

Optionally, the instruction information judging submodule 5012 is configured to: judge that the instruction information is a target application uninstallation instruction, when the short message information contains a first symbol and a name of an application; judge that the instruction information is a target communication record deletion instruction, when the short message information contains a second symbol and a contact name or contains a second symbol and a contact telephone number; and judge that the instruction information is a target picture file deletion instruction, when the short message information contains a third symbol and a picture folder name.

Optionally, when the instruction information is a target application uninstallation instruction, the operation executing module 502 is configured to: initiate, by the second mobile terminal, a service program according to the target application uninstallation instruction, and sending the first parameter corresponding to the name of the target application, which is acquired from the short message, to the service program; acquire, by the second mobile terminal, the first parameter corresponding to the name of the target application via the service program, and querying the name of an application package corresponding to the first parameter in prestored list information; and uninstall, by the second mobile terminal, the target application according to the queried application package name via the service program.

Optionally, the device further includes a correspondence acquiring module 503, configured to, before acquiring by the second mobile terminal the first parameter corresponding to the name of the target application: acquire, by the second mobile terminal, list information of all locally-installed applications via the service program; and acquire, by the second mobile terminal, a correspondence between the name of the package and the name of the application package in the list information, wherein, the list information at least includes the names of all applications installed and the names of the application packages.

Optionally, when the instruction information is a target communication record deletion instruction, the operation executing module 502 is configured to: initiate, by the second mobile terminal, a service program according to the target communication record deletion instruction, and sending a target contact name or a target telephone number in the target communication record as a second parameter to the service program; acquire, by the second mobile terminal, a second parameter corresponding to the target contact name or the target telephone number via the service program, and querying the contact name or the telephone number corresponding to the second parameter in a prestored communication list; and delete, by the second mobile terminal, the target communication record via the service program according to the contact name or the queried telephone number.

Optionally, when the instruction information is a target picture file deletion instruction, the operation executing module 502 is configured to: initiate, by the second mobile terminal, a service program according to the target picture file deletion instruction, and sending the target picture folder name as a third parameter to the service program; acquire, by the second mobile terminal, the third parameter via the service program, and querying the path information corresponding to the third parameter in a prestored picture file list; and delete, by the second mobile terminal, the target picture file via the service program according to the queried path information.

The above product may execute the method for controlling a mobile terminal according to any embodiment of this disclosure, and it has the corresponding functional modules and beneficial effects of the method.

### Embodiment 6

Embodiment 6 this disclosure provides a non-volatile computer storage medium, on which one or more modules are stored, when executed by a mobile terminal that executes the above method, the one or more modules can make the mobile terminal execute any method in the above embodiments.

### Embodiment 7

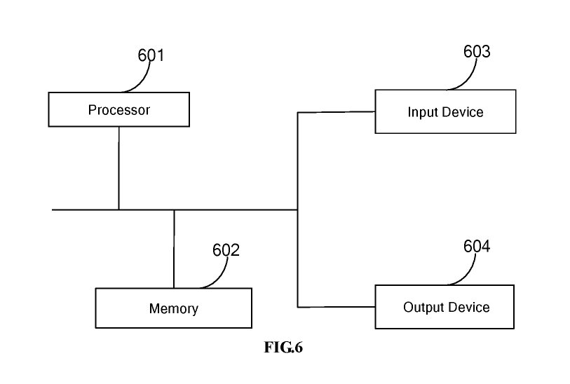

FIG. 6 is a schematic diagram showing the hardware structure of a mobile terminal according to Embodiment 7 of this disclosure; as shown in FIG. 6, the mobile terminal includes: one or more processors 601, and a memory 602; FIG. 6 shows an example in which the mobile terminal includes one processor 601.

The mobile terminal may further include: an input device 603 and an output device 604.

The processor 601, the memory 602, the input device 603 and the output device 604 in the mobile terminal may be connected via a bus or in other modes. FIG. 6 shows an example in which they are connected via a bus.

As a non-volatile computer-readable storage medium, the storage 602 may be configured to store a software program, a computer-executable program and a module, for example, the program instruction/module corresponding to the method for controlling a mobile terminal according to the embodiments of this disclosure (for example, the instruction information judging module 501 and the operation executing module 502 shown in FIG. 5). The processor 601 executes the functional application and data processing of a server by running the software programs, instructions and modules stored on the storage 602, thereby realizing the method for controlling a mobile terminal according to the above method embodiments.

The memory 602 may include a program storage region and a data storage region, wherein, the program storage region may be configured to store an operating system and at least one functional application program; and the data storage region may be configured to store the data created according to the use of a terminal device, etc. Additionally, the memory 602 may include a high random access memory, or it may further include a nonvolatile memory, for example, at least one disk storage apparatus, flash memory apparatus or other nonvolatile solid-state memory apparatuses. In some examples, the memory 602 may optionally include a memory set remotely relative to the processor 601, such a remote memory may be connected to a terminal device via a network. An example of the above network includes, but is not limited to, Internet, Intranet, Local Area Network (LAN), Mobile Communication Network and a combination thereof.

The input device 603 may be configured to receive digit or character information that is input and generating a key signal input related to the user setting and function control of the terminal. The output device 604 may include a display device, for example, a display screen, etc.

The one or more modules are stored on the memory 602. When executed by the one or more processors 601, the one or more modules will perform any method in the above embodiments.

It should be noted that, the above description only shows a part of the embodiments of this disclosure and the technical principles employed. It will be understood by one skilled in the art that, this disclosure is not limited to the specific embodiments described here, and many other equivalent embodiments may also be included without departing from the concept of this disclosure. Therefore, the scope of this disclosure should be defined by the scope of the claims appended.

The above product may execute the method provided by the embodiments of the present application, and has the corresponding functional modules of executing the method and advantageous effects. Technical details which are not exhaustively described in this embodiment may refer to the method provided by the embodiments of the present application.

The mobile terminal in embodiments of this application exists in various forms, including but not limited to:

(1) Mobile telecommunication device. A device of this kind has a feature of mobile communicating function, and has a main object of providing voice and data communication. Devices of this kind include smart phone (such as IPHONE), multi-media cell phone, functional cell phone, low-end cell phone and the like;

(2) Ultra mobile personal computer device. A device of this kind belongs to a category of personal computer, has functions of computing and processing, and generally has a feature of mobile internet access. Devices of this kind include PDA, MID, UMPC devices and the like, such as IPAD;

(3) Portable entertainment device. A device of this kind can display and play multi-media content. Devices of this kind include audio and video player (such as IPAD), handheld game player, e-book, intelligent toy and portable vehicle navigation device;

(4) Server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) Other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make essential of corresponding technical solutions depart from spirits and scope of technical solutions of various embodiments.

What is claimed is:

1. A method for controlling a mobile terminal, comprising:
at a second mobile terminal;
receiving short message information sent by a first mobile terminal, and judging whether the short message information contains instruction information; and
initiating, according to the instruction information, a service program to execute a corresponding operation, when it judges that the short message information contains instruction information.

2. The method according to claim 1, wherein, the judging whether the short message information contains instruction information comprises:
monitoring, via a short message application, the received short message information, and resolving content of the short message information; and
judging whether the content of the short message information contains instruction information.

3. The method according to claim 2, wherein, the instruction information includes: a target application uninstallation instruction, a target communication record deletion instruction and a target picture file deletion instruction.

4. The method according to claim 3, wherein, the judging whether the content of the short message information contains instruction information comprises:
judging that the instruction information is a target application uninstallation instruction, when the short message information contains a first symbol and a name of an application;
judging that the instruction information is a target communication record deletion instruction, when the short message information contains a second symbol and a contact name or contains a second symbol and a contact telephone number; and
judging that the instruction information is a target picture file deletion instruction, when the short message information contains a third symbol and a picture folder name.

5. The method according to claim 3, wherein, when the instruction information is a target application uninstallation instruction, the initiating, according to the instruction information, a service program to execute a corresponding operation comprises:
initiating a service program according to the target application uninstallation instruction, and sending a first parameter corresponding to a name of the target application, which is acquired from the short message, to the service program;
acquiring the first parameter corresponding to the name of the target application via the service program, and querying a name of an application package corresponding to the first parameter in prestored list information; and
querying the name of the application package via the service program, and uninstalling the target application.

6. The method according to claim 5, wherein, before acquiring the first parameter corresponding to the name of the target application, the method further comprises:
acquiring list information of all locally-installed applications via the service program; and
acquiring a correspondence between the name of the application package and the name of the application in the list information, wherein, the list information at least includes the names of all the installed applications and the names of the application packages.

7. A non-transitory computer storage medium storing computer-executable instructions for performing:
receiving short message information sent by a first mobile terminal, and judging whether the short message information contains instruction information; and
initiating, according to the instruction information, a service program to execute a corresponding operation, when it judges that the short message information contains instruction information.

8. The non-transitory computer storage medium according to the claim 7, wherein, the judging whether the short message information contains instruction information comprises:
monitoring, via a short message application, the received short message information, and resolving content of the short message information; and
judging whether the content of the short message information contains instruction information.

9. The non-transitory computer storage medium according to claim 8, wherein, the instruction information comprises: a target application uninstallation instruction, a target communication record deletion instruction and a target picture file deletion instruction.

10. The non-transitory computer storage medium according to claim 9, wherein, the judging whether the content of the short message information contains instruction information comprises:
judging that the instruction information is a target application uninstallation instruction, when the short message information contains a first symbol and a name of an application;
judging that the instruction information is a target communication record deletion instruction, when the short message information contains a second symbol and a contact name or contains a second symbol and a contact telephone number; and
judging that the instruction information is a target picture file deletion instruction, when the short message information contains a third symbol and a picture folder name.

11. The non-transitory computer storage medium according to claim 9, wherein, when the instruction information is a target application uninstallation instruction, the initiating, according to the instruction information, a service program to execute a corresponding operation comprises:
initiating a service program according to the target application uninstallation instruction, and sending a first parameter corresponding to a name of the target application, which is acquired from the short message, to the service program;
acquiring the first parameter corresponding to the name of the target application via the service program, and querying a name of an application package corresponding to the first parameter in prestored list information; and
querying the name of the application package via the service program, and uninstalling the target application.

12. The non-transitory computer storage medium according to claim 11, wherein, before acquiring the first parameter corresponding to the name of the target application, the method further comprises:
acquiring list information of all locally-installed applications via the service program; and
acquiring a correspondence between the name of the application package and the name of the application in the list information, wherein, the list information at least includes the names of all the installed applications and the names of the application packages.

13. A mobile terminal, comprising:
at least one processor; and
a memory communicably connected with the at least one processor for storing instructions executable by the at least one processor, wherein execution of the instructions by the at least one processor causes the at least one processor to:
receiving short message information sent by a first mobile terminal, and judging whether the short message information contains instruction information; and
initiating, according to the instruction information, a service program to execute a corresponding operation, when it judges that the short message information contains instruction information.

14. The mobile terminal according to the claim 13, wherein, the judging whether the short message information contains instruction information comprises:
monitoring, via a short message application, the received short message information, and resolving content of the short message information; and
judging whether the content of the short message information contains instruction information.

15. The mobile terminal according to claim 14, wherein, the instruction information comprises: a target application uninstallation instruction, a target communication record deletion instruction and a target picture file deletion instruction.

16. The mobile terminal according to claim 15, wherein, the judging whether the content of the short message information contains instruction information comprises:
judging that the instruction information is a target application uninstallation instruction, when the short message information contains a first symbol and a name of an application;
judging that the instruction information is a target communication record deletion instruction, when the short message information contains a second symbol and a contact name or contains a second symbol and a contact telephone number; and
judging that the instruction information is a target picture file deletion instruction, when the short message information contains a third symbol and a picture folder name.

17. The mobile terminal according to claim 15, wherein, when the instruction information is a target application uninstallation instruction, the initiating, according to the instruction information, a service program to execute a corresponding operation comprises:
initiating a service program according to the target application uninstallation instruction, and sending a first parameter corresponding to a name of the target application, which is acquired from the short message, to the service program;
acquiring the first parameter corresponding to the name of the target application via the service program, and querying a name of an application package corresponding to the first parameter in prestored list information; and
querying the name of the application package via the service program, and uninstalling the target application.

18. The mobile terminal according to claim 17, wherein, before acquiring the first parameter corresponding to the name of the target application, the method further comprises:
acquiring list information of all locally-installed applications via the service program; and
acquiring a correspondence between the name of the application package and the name of the application in the list information, wherein, the list information at least includes the names of all the installed applications and the names of the application packages.
